(19) United States
(12) Patent Application Publication
(10) Pub. No.: US 2014/0197804 A1
(43) Pub. Date: Jul. 17, 2014

(54) CHARGING SYSTEM AND CHARGING METHOD THEREOF

(71) Applicants: Inventec Appliances (Pudong) Corporation, Shanghai (CN); INVENTEC APPLIANCES (SHANGHAI) CO., LTD, Shanghai City (CN); INVENTEC APPLIANCES CORP., New Taipei City (TW)

(72) Inventors: I-Hsiu LIN, New Taipei City (TW); Sheng-Hung WANG, New Taipei City (TW); Hsin-Jung CHEN, New Taipei City (TW)

(73) Assignees: Inventec Appliances (Pudong) Corporation, Shanghai (CN); INVENTEC APPLIANCES (SHANGHAI) CO., LTD, Shanghai City (CN); INVENTEC APPLIANCES CORP., New Taipei City (TW)

(21) Appl. No.: 14/155,834

(22) Filed: Jan. 15, 2014

(30) Foreign Application Priority Data
Jan. 16, 2013 (CN) 201310016478.9

(51) Int. Cl. H02J 7/00

(52) U.S. Cl. CPC H02J 7/007
USPC 320/157; 320/160

(57) ABSTRACT

Disclosed is a charging system and a charging method thereof. The charging system is applicable for charging an electronic device by at least a charging device and includes a detecting module configured to detect a voltage of a power storage unit of the electronic device; and a control module. When the electronic device is in a turned-off state, the control module is configured to conduct charging the power storage unit by a first current of one of said at least a charging device, upon judging that the voltage is substantially lower than a first value, and the control module is also configured to conduct charging the power storage unit by a second current of one of said at least a charging device, upon judging that the voltage is substantially higher than or equal to the first value.

### CROSS-REFERENCE TO RELATED APPLICATION

This application claims the benefit of China Patent Application No. 201310016478.9, filed on Jan. 16, 2013, in the State Intellectual Property Office, the disclosure of which is incorporated herein its entirety by reference.

### BACKGROUND OF THE INVENTION

1. Field of the Invention

The present invention relates to a charging system and charging method thereof, in particular with respect to a charging system and charging method thereof for charging in accordance with electronic device state, types of charging device and charging period.

2. Description of the Related Art

With the advancement and development of technology along with needs for users, most of the current electronic devices are presented with thin and tiny shape. Whereas, the numbers of electronic devices especially tablet PC, cell, PDA and other mobile electronic devices, depend on employing rechargeable battery to provide power for electronic devices more often.

However, in order to satisfy with the needs for thinner and smaller size, the electronic devices are mostly provided with smaller battery to supply power. The prior art only aims at fast charging, excluding from plans for OFF mode charging, ON mode charging or Suspend mode charging, the battery or electronic device thus easily get damaged in process of charging, and what is worse is that it even causes combustion to the battery itself and results in cost.

To conclude the aforementioned problems, the applicant of the present application therefore designs a charging system and charging method thereof for overcoming the existing drawbacks to make it more applicable to industrial application.

### SUMMARY OF THE INVENTION

In view of the above technical problem, an object of the present invention is to provide a charging system and charging method thereof to tackle the obstacle of damage to rechargeable battery or electronic device caused by problems in the prior art.

In view of the problems, the present invention provides a charging system, applicable for charging an electronic device by at least a charging device. The charging system includes a detecting module and a control module. The detecting module is configured to detect a voltage of a power storage unit of the electronic device. When the electronic device is in a turned-off state, the control module also is configured to conduct charging the power storage unit by a first current of one of said at least a charging device, upon judging that the voltage is substantially lower than a first value, and the control module is configured to conduct charging the power storage unit by a second current of one of said at least a charging device, upon judging that the voltage is substantially higher than or equal to the first value.

Preferably, when the electronic device is in a turned-on state, the control module is configured for stopping charging the power storage unit, upon judging that the voltage is substantially higher than or equal to a second value.

Preferably, upon the electronic device being in a sleeping state, the control module is configured to conduct charging the electronic device when the electronic device is in a turned-on state.

Preferably, the charging system further comprises a timer for measuring duration of charging the power storage unit by said at least a charging device. In an embodiment, when the measured duration of charging by the second current reaches a first period and it's judged that the voltage is substantially higher than or equal to a second value, the control module is configured for stopping charging the power storage unit.

The present invention also provides a charging method for charging an electronic device by at least a charging device, wherein the electronic device has a control module and a power storage unit. The charging method includes detecting a voltage of the power storage unit of the electronic device; when the electronic device is in a turned-off state, the control module conducting charging the power storage unit by a first current of one of said at least a charging device, upon judging that the voltage is substantially lower than a first value; and when the electronic device is in a turned-off state, the control module conducting charging the power storage unit by a second current of one of said at least a charging device, upon judging that the voltage is substantially higher than or equal to the first value.

Preferably, the electronic device further has a tinier for measuring duration of charging the power storage unit by said at least a charging device, and the charging method further comprises the control module directing said at least a charging device to stop charging the power storage unit, when the measured duration of charging reaches a preset period.

Preferably, the charging method further includes when the electronic device is in a turned-on state, the control module directing said at least a charging device to stop charging the power storage unit, upon judging that the voltage is substantially higher than or equal to a second value.

Preferably, the charging method further includes upon the electronic device being in a sleeping state, the control module conducting charging the electronic device when the electronic device is in a turned-on state.

Preferably, the electronic device further comprises a timer for measuring duration of charging the power storage unit by said at least a charging device, and the charging method further comprises when the measured duration of charging by the second current reaches a first period and its judged that the voltage is substantially higher than or equal to a second value, the control module conducting stopping charging the power storage unit.

Preferably, the electronic device further comprises a timer for measuring duration of charging the power storage unit by said at least a charging device, and the charging method further comprises detecting the voltage or a temperature of the power storage unit when the measured duration of charging by the second current reaches a second period; and the control module conducting stopping charging the power storage unit upon judging that the voltage is substantially higher than or equal to a fourth value or the temperature is substantially higher than or equal to a level of temperature.

### BRIEF DESCRIPTION OF THE DRAWINGS

FIG. 1 is a block diagram of charging system in accordance with the present invention.

FIG. 2 is a detecting flow diagram of charging system in accordance with the present invention.

FIG. 3 is a first flow diagram of charging system is in a turned-off state in accordance with the present invention.

FIG. 4 is a second flow diagram of charging system is in a turned-off state in accordance with the present invention.

FIG. 5 is a third flow diagram of charging system is in a turned-off state in accordance with the present invention.

FIG. 6 is a charging flow diagram of charging system is in a turned-on state in accordance with the present invention.

FIG. 7 is a charging flow diagram of charging system is in a sleeping state in accordance with the present invention.

FIG. 8 is a step diagram of charging method in accordance with the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

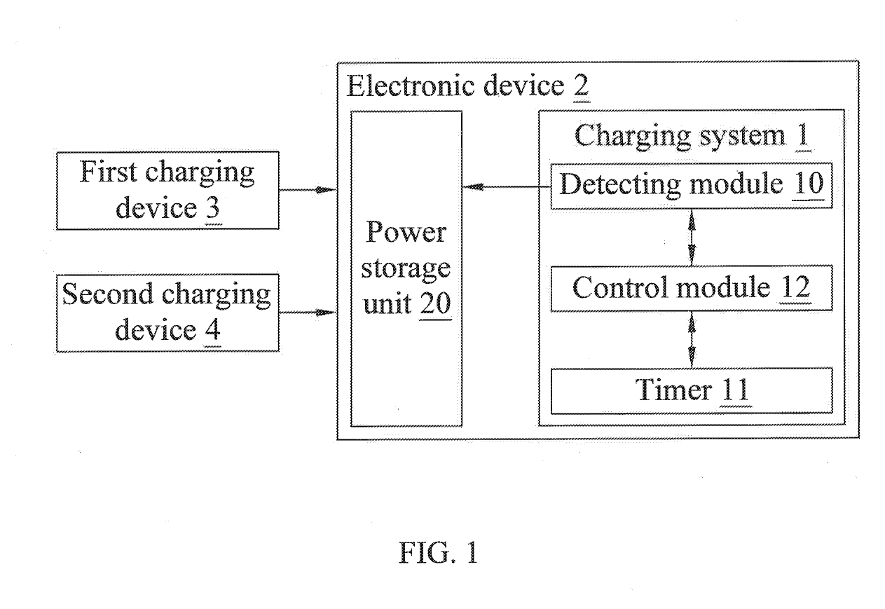

With reference to FIG. 1 for a block diagram of charging system in accordance with the present invention. As shown in the FIG, a charging system 1 is provided, applicable for an electronic device 2, wherein the electronic device 2 may be tablet PC, smartphone, PDA or other mobile electronic devices. The charging system 1 comprises a detecting module 10, a timer 11 control module 12. The detecting module 10 and timer 11 are electronically connected to the control module 12, respectively, in which the control module 12 may be the built-in control module of the electronic device 2, and may also be an additional arrangement of control module, which may be the sample aspect of the control module 12 is the built-in control module of the electronic device 2 in accordance with the present embodiment, but shall not be subject to this restriction.

Wherein the detecting module 10 detects executing state of the electronic device 2 or the type of charging device by connecting to control module 12 (ex. first charging device 3 or second charging device 4), to respectively generate a state signal and a detecting signal, and the detecting module 10 connects to a power storage unit 20 of the electronic device 2 to acquire voltage of the power storage unit 20. The timer 11 acquires charging duration by connecting to control module 12 and thus measuring charging duration. The control module 12 further decides the charging ways of the electronic device 2 or whether conducting charging based on state signal, detecting signal, voltage, measured charging duration or combination thereof.

By the way, the detecting module 10 may include charging device identification unit, state identification unit and electrical quantity identification unit, wherein the charging device identification unit may be a charging identification circuit. Take USB interface for example, by monitoring the potential and electric current change of two primary signal lines, D+ and D−, further determining the current connection apparatus is a regular USB interface, a specific adaptor, a USB interface with charging function, or the charging device identification unit may be served as the charging identification chip; and state detecting unit may be a state identification circuit, for example, when the electronic device 2 is in a turned-off, turned-on or sleeping state, different power consumption is generated and the state identification circuit may make an judgment in accordance with different state of the power consumption. The power identification, however, is known to a skilled person in the art and unnecessary details are no longer being given hereinafter. Furthermore, the charging identification and state identification are also known to a skilled person in the art, and the above-mentioned is only an exemplary embodiment, shall not be subject to this restriction.

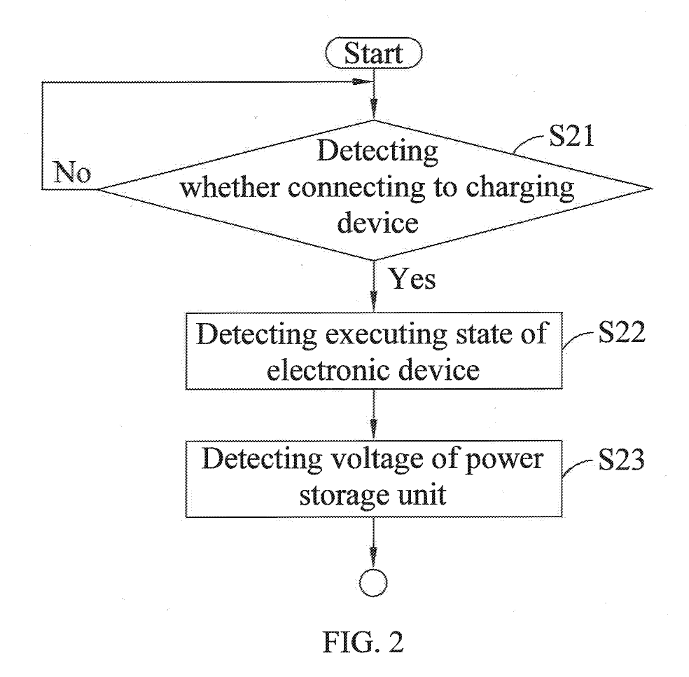

With reference to FIG. 2 for a detecting flow diagram of charging system in accordance with the present invention.

Firstly, detecting module 10 detects whether the electronic device 2 connecting to charging device, if connects, it further determines that the charging device conducts charging to the electronic device 2 is the first charging device 3 (ex. connecting to power supplied electronic device by USB) or the second charging device 4 (ex. connecting to indoor plug by power connector) to generate a detecting signal (ex. S21). Then, the detecting module 10 further detects which type the electronic device 2 conducts (ex. turned-off state, turned-on state or sleeping state) to generate a state signal (ex. S22). And then, the detecting module 10 detects the voltage of the power storage unit 20 of the electronic device 2 (ex. S23).

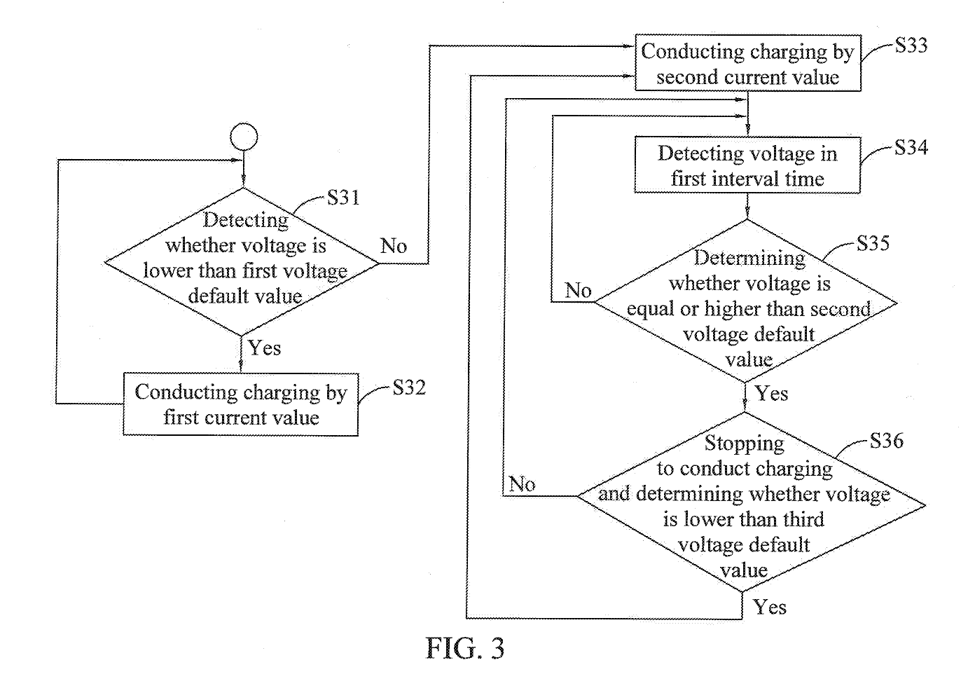

With reference to FIGS. 3, 4 and 5 for a first to third flow diagrams of charging system is in a turned-off state in accordance with the present invention. The process in FIG. 3 continues following S23 in FIG. 2. As shown in the FIGS., when the control module 12 determines that the electronic device 2 is in a turned-off state based on the state signal, the control module 12 determines that whether the voltage of power storage unit 20 is lower than a voltage default value, for example, 3.56 V (ex. S31); if, conducting charging to the power storage unit 20 by a first current value (ex. S302), wherein the first current value may be default charging current utilizing Power Management IC. It is noteworthy that in the process S32, if the detecting module 10 still proceeds to detect voltage, so that the control module 12 keeps determining whether the voltage is lower than the first voltage default value. When the voltage is equal or higher than the first voltage default value, the control module 12 controls the second voltage default value corresponding to the first charging device 3 or the second charging device 4 to conduct charging (ex. S33). For example, when the voltage is equal or higher than the first voltage default value and conducts charging by the first charging device 3, the control module 12 conducts charging by the second current value of 480 mA, and when the voltage is equal or higher than the first voltage default value, executing in a turned-on state. If conducting charging by the second charging device 4, when the voltage is lower than the first voltage default value, conducting charging by the first current value of the control module 12, 160 mA is served as the value in the exemplary embodiment. If the voltage is equal or higher than the first voltage default value, the control module 12 conducts charging by the second current value of 1120 mA. According to the aforementioned, the second current value of 480 mA or 1120 mA only explains that the control module 12 may conduct charging by different second current value based on different charging device to protect the power storage unit from being damaged, consequently, it shall not, be subject to this restriction.

In addition, the charging system 1 may further being arranged as when conducting charging by the first charging device 3, if the voltage is lower than the first voltage default value, processing into a precharging state in advance, and conducting charging by the first current value in the precharging state, while the voltage is equal or higher than the first voltage default value, conducting into a turned-on state. After turning on is done, utilizing the second current value corresponding to the first charging device 3 to conduct charging. On the other hand, when conducting charging by the second charging device 4 is being detected, conducting into the precharging state, and conducting charging by the second current value of the second charging device 4 till the charging is completed, and then turning off until the voltage is equal or higher than the first voltage default value.

In process of charging, the control module 12 controls the detecting module 10 to conduct detecting the voltage in an interval time based on the charging duration measured by the timer 11 and a first interval time ex. S34), if the voltage is equal or higher than a second voltage default value, stopping to charging (ex. S35); if the voltage is lower than a third voltage default value, continuing to conduct charging (ex. S36). For example, the charging system 1 may read the voltage or charging current in every 10 minutes (first interval time value) through the charging duration measured by the timer 11; when the voltage reaches to 4.08 V (second voltage default value) or the charging current is lower than 130 mA, Charging Full is thus determined, and stopping to charging. Furthermore, the electronic device 2 notifies that the charging is completed by a notification unit at the time (ex. LED), and in practical application, setting the notification unit turns on when starting to conduct charging and turning off the notification unit when the charging is completed, but shall not be subject to this restriction. After the charging is done, the charging system 1 keeps reading the voltage in every 10 minutes, when the voltage is lower than 3.8 V (third voltage default value), determining the Charging Full is uncompleted, and thus restarting to conduct charging.

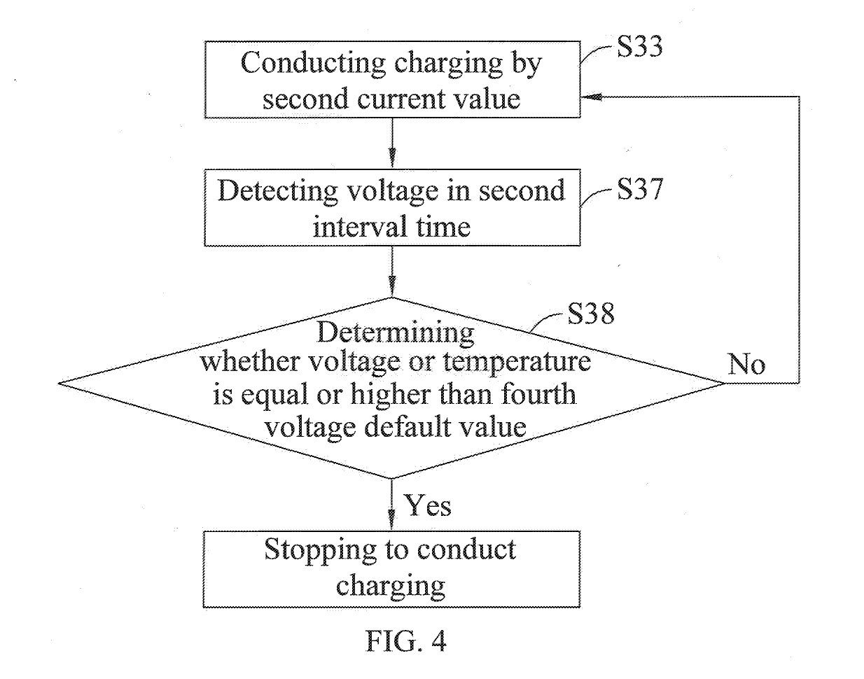

In addition, as shown in FIG. 4, the control module 12 may control the detecting module 10 to detect a voltage or a temperature of the power storage unit 20 based on the time signal and a second interval time (ex. S37); when the control module 12 determines that the voltage is equal or higher than a fourth voltage or the temperature is higher than a temperature default value, stopping to conduct charging (ex. S38). More specifically, the control module 12 reads the voltage or temperature of the power storage unit 20 in every 10 minutes by the timer 11, if the voltage or the temperature is too high or too low (ex. over 4.13 V or higher than 45 ° C. or lower than 0° C.), stopping to conduct charging. Wherein the second interval time may set as the same as the first interval time to proceed to detect together, but shall not be subject to this restriction.

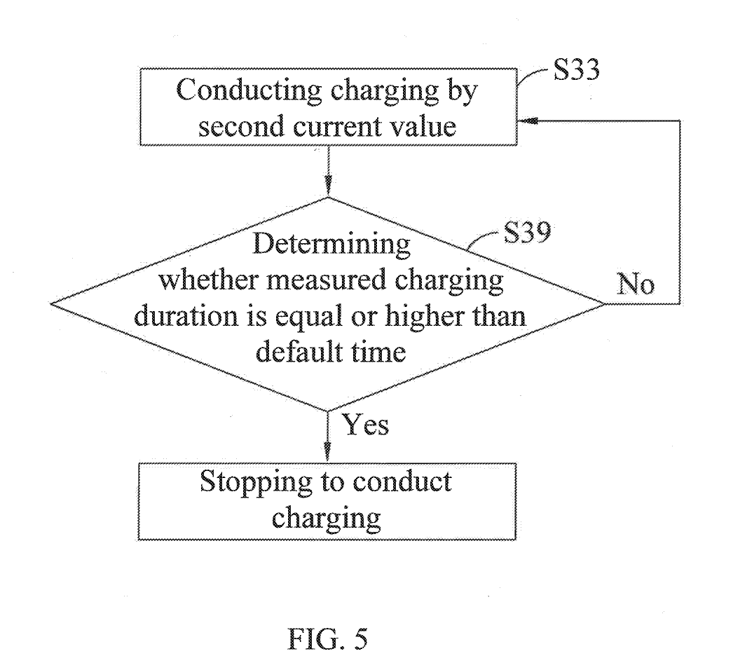

As shown in FIG. 5, in process of charging, the control module 12 may determine that whether the time signal is equal or higher than a default time value, if so, stopping to conduct charging (ex. S39). In practical application, the default time value may be set as different value in response to the first charging device 3 or second charging device, respectively. For example, setting the default time value as 24 hours when utilizing the first charging device 3 and setting the default time value as 12 hours when utilizing the second charging device 4, so that managing the charging duration according to different charging device to further protect the charging.

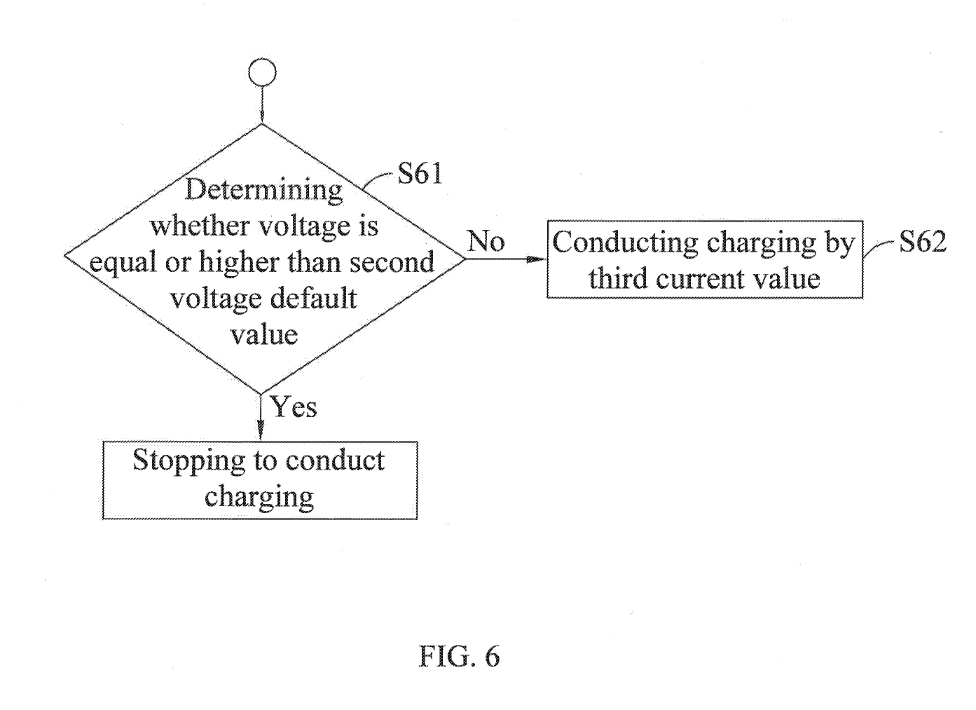

With reference to FIG. 6 for a charging flow diagram of charging system is in a turned-on state in accordance with the present invention. The process in FIG. 6 continues following S23 in FIG. 2. As shown in the FIG., when the control module 12 determines that the electronic device 2 is in a turned-on state based on the state signal, the control module 12 determines that whether the voltage is equal or higher than the second voltage default value (ex. S61); if so, stopping to conduct charging; if not, controlling the third current value corresponding to the first charging device 3 or the second charging device 4 to conduct charging to the power storage unit 20 (ex. S62). For example, in the turned-on state, examining the voltage of the power storage unit 20 at the beginning, if over 4.08 V (second voltage default value), namely, the power storage unit 20 is in Charging Full state, and charging is unnecessary. On the contrary, conducting charging with 480 mA to correspond to the first charging device 3 and with 1120 mA (third current value) to correspond to the second charging device 4.

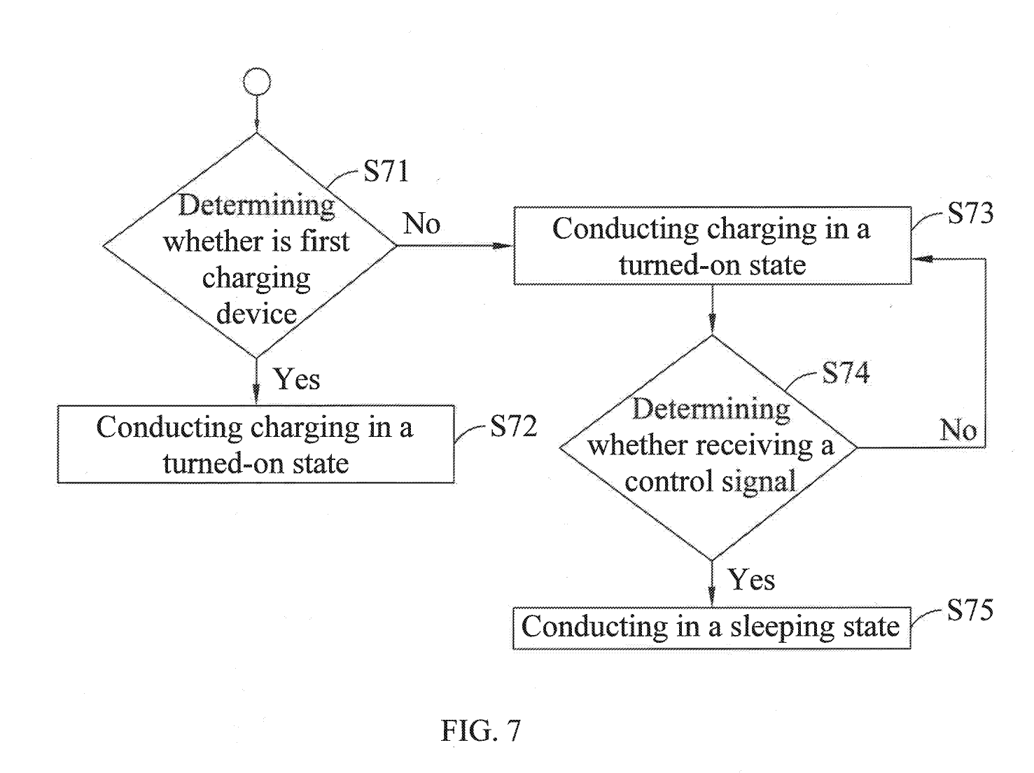

With reference to FIG. 7 for a charging flow diagram of charging system is in a sleeping state in accordance with the present invention. The process in FIG. 7 continues following S23 in FIG. 2. As shown in the FIG., when the control module 12 determines that the electronic device 2 is in a sleeping state based on the state signal, the control module 12 determines whether is the first charging device 3 at the time (ex. S71); if so, controlling the electronic device 2 conducts charging in the turned-on state (ex. S72), when the electronic device 2 conducts charging in the turned-on state, namely, it belongs to a charging state in a turned-on state, and unnecessary details are no longer being given hereinafter. In the present embodiment, however, the first charging device 3 demonstrates an aspect by means of connecting to power supplied electronic device by USB (ex. computer), but as the reason for it may be unsatisfied with the demand for transmitting data at the same time, as a result, setting the electronic device 2 being incapable of conducting in the sleeping state at the time, but shall not be subject to this restriction. If determining as the second charging device 4, conducting charging in the turned-on state as the same (ex. S73); then, determining whether receiving a control signal (ex. S74), such as the control button (ex. power button) of the electronic device 2 or the control signal generated by an automatic locking module built-in the electronic device 2; if so, conducting charging in the sleeping state (ex. S75). Wherein, when the electronic device 2 is in a sleeping state, it may proceed to detect voltage in every 10 minutes and under the circumstance of the backlight of the screen is closed, to ensure that whether the power storage unit 20 reaches to Charging Full state, and through the state of the backlight of the screen is closed, further avoids the user from being bothered due to detect voltage.

To sum up, it can be realized that the processes, S34-S36, S37-S38 and S39 in the turned-off state may also be applicable to the turned-on or sleeping state, such as detecting voltage in every duration and stopping to conduct charging when the voltage of the power storage unit 20 is over the aforementioned default value or temperature. For the sake of being brief, unnecessary details are no longer being given hereinafter.

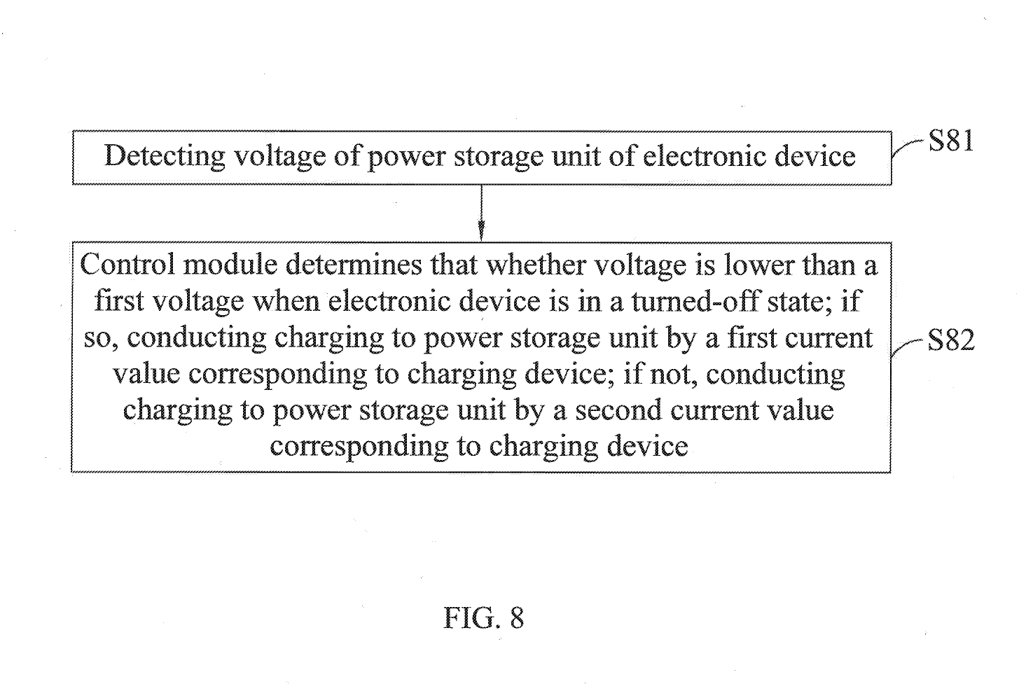

With reference to FIG. 8 for a step diagram of charging method in accordance with the present invention. As shown in the FIG., the charging method of the present invention is applicable to the above-mentioned electronic device of charging system. The charging method comprises the following steps:

(S81) detecting voltage of the power storage unit of the electronic device;

(S82) the control module determines that whether the voltage is lower than a first voltage when the electronic device is in a turned-off state; if so, conducting charging to the power storage unit by a first current value corresponding to the charging device; if not, conducting charging to the power storage unit by a second current value corresponding to the charging device.

Furthermore, there are one or more possible advantages as follows in accordance with the charging system or the charging method thereof of the present invention:
(1) The charging system and charging method thereof may determine which type of charging device by means of the detecting module so as to control the corresponding charging electricity to conduct charging, so that an efficiently charging protection can be provided.
(2) The charging system and charging method thereof may determine the current state of electronic device by means of detecting module so as to control the corresponding charging electricity to conduct charging, so that an efficiently charging protection can be provided.
(3) The charging system and charging method thereof may determine the current state of electronic device by means of the voltage of power storage unit of electronic device so as to control the corresponding charging electricity to conduct charging, so that an efficiently charging protection can be provided.
(4) The charging system and charging method thereof may obtain the charging duration by means of timer so as to control whether to conduct charging, so that to avoid the p storage unit or electronic device from being damaged because of overcharge.

The detail and embodiment for the charging method of the charging system of the present invention have been elaborated upon the aforementioned description, and for the sake of being brief, unnecessary details are no longer being given hereinafter.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A charging system, applicable for charging an electronic device by at least a charging device, comprising:
a detecting module configured to detect a voltage of a power storage unit of the electronic device; and
a control module, wherein when the electronic device is in a turned-off state, the control module is configured to conduct charging the power storage unit by a first current of one of said at least a charging device, upon judging that the voltage is substantially lower than a first value, and the control module is also configured to conduct charging the power storage unit by a second current of one of said at least a charging device, upon judging that the voltage is substantially higher than or equal to the first value.

2. The charging system of claim 1, wherein when the electronic device is in a turned-on state, the control module is configured for stopping charging the power storage unit, upon judging that the voltage is substantially higher than or equal to a second value.

3. The charging system of claim 2, wherein when the electronic device is in a turned-on state, the control module is configured to conduct charging the power storage unit by a third current of one of said at least a charging device, upon judging that the voltage is substantially lower than the second value.

4. The charging system of claim 1, wherein upon the electronic device being in a sleeping state, the control module is configured to conduct charging the electronic device when the electronic device is in a turned-on state.

5. The charging system of claim 4, wherein the control module is configured to conduct charging the electronic device in the sleeping state, upon the control module receiving a control signal.

6. The charging system of claim 1, further comprising a timer for measuring duration of charging the power storage unit by said at least a charging device.

7. The charging system of claim 6, wherein when the measured duration of charging by the second current reaches a first period and it's judged that the voltage is substantially higher than or equal to a second value, the control module is configured for stopping charging the power storage unit.

8. The charging system of claim 7, wherein upon stopping charging the power storage unit, if it's judged that the voltage is substantially lower than a third value, the control module is configured to conduct charging the power storage unit and to conduct the electronic device into a turned-on state.

9. The charging system of claim 7, wherein upon stopping charging the power storage unit, if it's judged that the voltage is substantially lower than a third value, the control module is configured to conduct charging the power storage unit to conduct the electronic device in a precharging state.

10. The charging system of claim 6, wherein the detecting module is configured to detect the voltage or a temperature of the power storage unit when the measured duration of charging by the second current reaches a second period, and the control module is configured for stopping charging the power storage unit upon judging that the voltage is substantially higher than or equal to a fourth value or the temperature is substantially higher than or equal to a level of temperature.

11. A charging method for charging an electronic device by at least a charging device, wherein the electronic device has a control module and a power storage unit, and the charging method comprises:
detecting a voltage of the power storage unit of the electronic device;
when the electronic device is in a turned-off state, the control module conducting charging the power storage unit by a first current of one of said at least a charging device, upon judging that the voltage is substantially lower than a first value; and
when the electronic device is in a turned-off state, the control module conducting charging the power storage unit by a second current of one of said at least a charging device, upon judging that the voltage is substantially higher than or equal to the first value.

12. The charging method of claim 11, wherein the electronic device further has a timer for measuring duration of charging the power storage unit by said at least a charging device, and the charging method further comprises the control module directing said at least a charging device to stop charging the power storage unit, when the measured duration of charging reaches a preset period.

13. The charging method of claim 11, further comprising when the electronic device is in a turned-on state, the control module directing said at least a charging device to stop charging the power storage unit, upon judging that the voltage is substantially higher than or equal to a second value.

14. The charging method of claim 13, further comprising when the electronic device is in a turned-on state, the control module conducting charging the power storage unit by a third current of one of said at least a charging device, upon judging that the voltage is substantially lower than the second value.

15. The charging method of claim 11, further comprising upon the electronic device being in a sleeping state, the control module conducting charging the electronic device when the electronic device is in a turned-on state.

16. The charging method of claim 15, further comprising the control module conducting charging the electronic device in the sleeping state, upon the control module receiving a control signal.

17. The charging method of claim 11, wherein the electronic device further comprises a timer for measuring duration of charging the power storage unit by said at least a charging device, and the charging method further comprises when the measured duration of charging by the second current reaches a first period and it's judged that the voltage is substantially higher than or equal to a second value, the control module conducting stopping charging the power storage unit.

18. The charging method of claim 17, further comprising upon stopping charging the power storage unit, if it's judged that the voltage is substantially lower than a third value, the control module conducting charging the power storage unit and conducting the electronic device into a turned-on state.

19. The charging method of claim 17, further comprising upon stopping charging the power storage unit, if it's judged that the voltage is substantially lower than a third value, the control module conducting charging the power storage unit to conduct the electronic device in a precharging state.

20. The charging method of claim 11, wherein the electronic device further comprises a timer for measuring duration of charging the power storage unit by said at least a charging device, and the charging method further comprises:
detecting the voltage or a temperature of the power storage unit when the measured duration of charging by the second current reaches a second period; and
the control module conducting stopping charging the power storage unit upon judging that the voltage is substantially higher than or equal to a fourth value or the temperature is substantially higher than or equal to a level of temperature.
